(19) United States
(12) Patent Application Publication
(10) Pub. No.: US 2022/0405104 A1
(43) Pub. Date: Dec. 22, 2022

(54) CROSS PLATFORM AND PLATFORM AGNOSTIC ACCELERATOR REMOTING SERVICE

(71) Applicant: VMware, Inc., Palo Alto, CA (US)

(72) Inventors: Tiejun Chen, Beijing (CN); Olivier Alain Cremel, Los Altos, CA (US); Kit Colbert, Mountain View, CA (US); Chris Wolf, Draper, UT (US); Mazhar Memon, Austin, TX (US); Renu Raman, Palo Alto, CA (US); Peter Buckingham, Palo Alto, CA (US); Shreekanta Das, San Jose, CA (US)

(21) Appl. No.: 17/377,893

(22) Filed: Jul. 16, 2021

(30) Foreign Application Priority Data
Jun. 22, 2021 (CN) PCT/CN2021/101491

(51) Int. Cl. G06F 9/38; G06F 9/451; G06F 9/54

(52) U.S. Cl. CPC G06F 9/3895; G06F 9/3877; G06F 9/452; G06F 9/545

(57) ABSTRACT

Disclosed are various examples of providing cross platform accelerator remoting between complex instruction set computer (CISC) components and reduced instruction set computer (RISC) components of a computing environment. An accelerator remoting server receives accelerator instructions executable by a locally installed accelerator device and provides the accelerator instructions to the accelerator device. The accelerator remoting server transmits accelerator results to an accelerator remoting client to complete the cross platform or platform agnostic accelerator remoting.

### CROSS-REFERENCE TO RELATED APPLICATIONS

This application is a bypass continuation-in-part of International Application No. PCT/CN2021/101491, filed on Jun. 22, 2021 and entitled “CROSS PLATFORM AND PLATFORM AGNOSTIC ACCELERATOR REMOTING SERVICE,” which is hereby incorporated herein by reference in its entirety.

### BACKGROUND

Privately hosted solutions can have hand-picked hardware located in a limited number of facilities. Even if the number of facilities is high, if an end user is in control of most or all of the hardware deployment, the hardware selection can be finely tuned for the enterprise. However, many enterprises are moving to public-cloud based infrastructures, and augmenting existing deployments using contracted hardware provided through a public cloud, or public wide area network such as the Internet. Public-cloud based infrastructures and providers can provide the ability to quickly scale up enterprise capabilities. Public cloud infrastructures are expanding to include various different hardware types.

Enterprises can also use hardware accelerators for enterprise functionalities. Hardware accelerators can more quickly accomplish artificial intelligence, machine learning, graphics acceleration, and other tasks. The hardware accelerators deployed in public, private, hybrid cloud, and multi-cloud infrastructures can have multiple different manufacturers and types. However, existing services can be tied to a particular type of hardware, limiting the ability to take full advantage of heterogeneous hardware of modern public cloud, private cloud, hybrid cloud, and multi-cloud deployments.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of an example of a networked environment that includes components that provide a framework for a cross platform and platform agnostic accelerator remoting service.

FIG. 2 is a drawing that provides an example of the operation of components of the networked environment of FIG. 1.

FIG. 3 is another drawing that provides an example of the operation of components of the networked environment of FIG. 1.

FIG. 4 is a sequence diagram illustrating functionality implemented by components of the networked environment.

FIG. 5 is a flowchart illustrating functionality implemented by components of the networked environment.

FIG. 6 is a flowchart illustrating functionality implemented by components of the networked environment.

### DETAILED DESCRIPTION

The present disclosure relates to providing an accelerator remoting service for private cloud, public cloud, hybrid cloud, and multi-cloud infrastructures. In various examples, the mechanisms described enable cross platform and platform agnostic operation of the accelerator remoting service. Machine learning, artificial neural networks, artificial intelligence (AI) applications and other processes can be performed using a wide variety of specialized hardware accelerator devices. Enterprises can utilize public-cloud based infrastructures and augment existing deployments using hardware provided through a public cloud or public wide area network such as the Internet. Public-cloud based infrastructures and providers can provide the ability to quickly scale up enterprise capabilities. Public cloud infrastructures are expanding to include various different hardware types. Enterprises can also use hardware accelerators for enterprise functionalities. Hardware accelerators can more quickly accomplish artificial intelligence, machine learning, graphics acceleration, and other tasks. The hardware accelerators deployed in private cloud, public cloud, hybrid cloud, and multi-cloud infrastructures can have multiple different manufacturers and types. Existing services can be tied to a particular type of processor hardware and can limit the ability to one type limiting the ability to take full advantage of heterogeneous hardware various types of cloud deployments. However, the present disclosure describes mechanisms that provide a cross platform accelerator remoting service that enables accelerator remoting clients executed on hardware that uses one type of processor to utilize remote accelerator devices. In some cases, the mechanisms can provide remoting whether the remote accelerator device uses the same or another type of processor. In other words, the cross platform accelerator remoting service can also be platform agnostic.

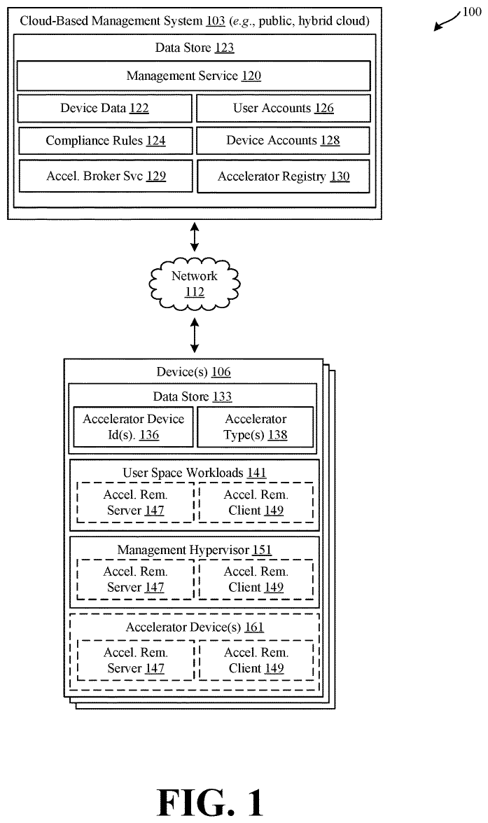

With reference to FIG. 1, shown is an example of a networked environment 100. The networked environment 100 can include a cloud-based management system 103, devices 106, and other components in communication with one another over a network 112. In some cases, devices 106 can include host computing devices of a private cloud, public cloud, hybrid cloud, and multi-cloud infrastructures. Hybrid cloud infrastructures can include public and private host computing devices. Multi-cloud infrastructures can include multiple different computing platforms from one or more service providers in order to perform a vast array of enterprise tasks.

The devices 106 can also include client devices and Internet-of-Things (IoT) devices 113, among other devices that can connect to the network 112 directly or through an edge device or gateway. The components of the networked environment 100 can be utilized to provide platform-agnostic remote access to the accelerator devices 161.

The network 112 can include the Internet, intranets, extranets, wide area networks (WANs), local area networks (LANs), wired networks, wireless networks, other suitable networks, or any combination of two or more such networks. The networks can include satellite networks, cable networks, Ethernet networks, telephony networks, and other types of networks.

The cloud-based management system 103 can include a server computer or any other system providing computing capability. While referred to in the singular, the cloud-based management system 103 can include a plurality of computing devices that are arranged in one or more server banks, computer banks, or other arrangements. The cloud-based management system 103 can include a grid computing resource or any other distributed computing arrangement. The cloud-based management system 103 can be customer or enterprise-specific. The computing devices of the cloud-based management system 103 can be located in a single installation or can be distributed among many different geographical locations local and/or remote from the other components. The cloud-based management system 103 can also include or be operated as one or more virtualized computer instances. For purposes of convenience, the cloud-based management system 103 is referred to herein in the singular. Even though the cloud-based management system 103 is referred to in the singular, it is understood that a plurality of cloud-based management systems 103 can be employed in the various arrangements as described above.

The components executed on the cloud-based management system 103 can include a management service 120, as well as other applications, services, processes, systems, engines, or functionality not discussed in detail herein. The management service 120 can be stored in the data store 123 of the cloud-based management system 103. While referred to generally as the management service 120 herein, the various functionalities and operations discussed can be provided using a management service 120 that includes a scheduling service and a number of software components that operate in concert to provide compute, memory, network, and data storage for enterprise workloads and data. The management service 120 can also provide access to the enterprise workloads and data provided by the devices 106 and can be accessed using client devices that can be enrolled in association with a user account 126 and related credentials.

The management service 120 can communicate with associated management instructions of the devices 106, including host devices, client devices, and IoT devices to ensure that these devices comply with their respective compliance rules 124, whether the specific device 106 is used for computational or access purposes. If the devices 106 fail to comply with the compliance rules 124, the respective management instructions can discontinue access and enterprise workload processing in communication with the management service 120.

The data store 123 can include any storage device or medium that can contain, store, or maintain the instructions, logic, or applications described herein for use by or in connection with the instruction execution system. The data store 123 can be a hard drive or disk of a host, server computer, or any other system providing storage capability. While referred to in the singular, the data store 123 can include a plurality of storage devices that are arranged in one or more hosts, server banks, computer banks, or other arrangements. The data store 123 can include any one of many physical media, such as magnetic, optical, or semiconductor media. More specific examples include solid-state drives or flash memory. The data store 123 can include memory of the cloud-based management system 103, mass storage resources of the cloud-based management system 103, or any other storage resources on which data can be stored by the cloud-based management system 103.

The data stored in the data store 123 can include management data including device data 122, enterprise data, compliance rules 124, user accounts 126, and device accounts 128, as well as other data. Device data 122 can identify devices 106 by one or more device identifiers, a unique device identifier (UDID), a media access control (MAC) address, an internet protocol (IP) address, or another identifier that uniquely identifies a device with respect to other devices. The device identifiers can include accelerator device identifiers 136 for accelerator devices 161 that can be installed on a particular device 106, as well as an accelerator type 138 of the accelerator device 161. Accelerator devices 161 can include graphics processing units (GPUs), tensor processing units (TPUs), application-specific integrated circuits (ASICs), field programmable gate arrays (FPGAs), and other types of special-purpose processing units or coprocessor units. Accelerator devices 161 can be connected to a device 106 through a universal serial bus (USB) connection, a Peripheral Component Interconnect Express (PCI-e) or mini-PCI-e connection, or another physical connection.

Accelerator devices 161 can further include processor-integrated networking accelerator devices 161. Processor-integrated networking accelerator devices 161 can include networking devices such as network interface cards (NICs) that are integrated to include both special-purpose processing units capable of processing AI computations and a data processing unit (DPU) that can process complex instruction set computer (CISC) instructions or reduced instruction set computer (RISC) instructions that are typically performed by a central processing unit (CPU) that includes a CISC architecture or a RISC architecture. These NIC devices can include smart or intelligent NICs from BROADCOM®, NVIDIA®, SOLARFLARE®, SMARTNIC®, NETRONOME®, XILINX®, and INTEL® among others. Accelerator devices 161 can be used for artificial intelligence (AI) processing, graphics processing, sound processing, signal processing, and other special purpose applications.

CISC instructions can execute multi-step operations including load and store in a single instruction. The CISC architectures can include x86 instruction set architectures that can perform x86 instructions, including one or more of 32 bit x86 (x86-32), 64 bit x86 (x86-64) and other x86-based instructions. RISC designs can use uniform instruction length for instructions and can employ separate load and store instructions; RISC architectures cannot execute multi-step operations including load and store in a single instruction. The RISC architectures can include ARM instruction set architectures that can perform ARM instructions, including 64 bit ARM (ARM-64) and other ARM based instructions.

The device data 122 can include an enrollment status indicating whether each device 106 is enrolled with or managed by the management service 120. For example, a client device 106, edge device 106, or IoT device 106 designated as “enrolled” can be permitted to access the enterprise workloads and data hosted by other devices 106, while those designated as “not enrolled,” or having no designation, can be denied access to the enterprise resources. The device data 122 can further include indications of the state of devices including the client devices, IoT devices, edge devices, host devices, and others. While a user account 126 can be associated with a particular person as well as devices 106, a device account 128 can be unassociated with any particular person, and can nevertheless be utilized for a client device 106, edge device 106, or IoT device 106 that provides automatic functionalities.

Device data 122 can also include data pertaining to user groups. An administrator can specify one or more of the devices 106 as belonging to a user group. The user group can refer to a group of user accounts 126, which can include device accounts 128. User groups can be created by an administrator of the management service 120.

Compliance rules 124 can include, for example, configurable criteria that must be satisfied for devices 106 to be in compliance with the management service 120. The compliance rules 124 can be based on a number of factors, including geographical location, activation status, enrollment status, and authentication data, including authentication data obtained by a device registration system, time, and date, and network properties, among other factors associated with each device. The compliance rules can also be determined based on a user account 126 associated with a user.

Compliance rules 124 can include predefined constraints that must be met in order for the management service 120, or other applications, to permit devices 106 access to enterprise data and other functions of the management service 120. The management service 120 can communicate with management instructions on the devices 106 to determine whether states exist on the device 106 which do not satisfy one or more of the compliance rules 124. States can include, for example, a virus or malware being detected on the device; installation or execution of a blacklisted application; and/or a device being “rooted” or “jailbroken,” where root access is provided to a user of the device. Additional states can include the presence of particular files, questionable device configurations, vulnerable versions of applications, vulnerable states of the devices 106 or other vulnerability, as can be appreciated.

The management service 120 can oversee the management and resource scheduling for devices 106. The management service 120 can transmit various software components, including enterprise workloads, enterprise data, and other enterprise resources for processing and storage using the various host devices 106. An enterprise workload can include an application that has accelerator instructions that are processed using an accelerator device 161. Accelerator instructions can include Compute Unified Device Architecture (CUDA) instructions, Open Computing Language (OpenCL), and others.

The devices 106 can include host devices such as a server computer or any other system providing computing capability, including those that compose the cloud-based management system 103. Devices 106 can include public, private, hybrid cloud and multi-cloud devices that are operated by third parties with respect to the management service 120. The devices 106 can be located in a single installation or can be distributed among many different geographical locations local and/or remote from the other components.

The devices 106 can have locally connected accelerator devices 161. The accelerator devices 161 can be connected to the edge device 106 through a universal serial bus (USB) connection, a Peripheral Component Interconnect Express (PCI-e) or mini-PCI-e connection, or another physical connection. Accelerator devices 161 can include a hardware accelerator specialized to perform artificial neural networks, machine vision, machine learning, and other types of special purpose instructions written using CUDA, OpenCL, C++, and other instructions. The accelerator devices 161 can utilize in-memory processing, low-precision arithmetic, and other types of techniques. An accelerator device 161 can be associated with an accelerator device identifier 136 and an accelerator type 138. The accelerator device identifier 136 can include a unique device identifier of the accelerator device, which can be assigned by the manufacturer or the management service 120. The accelerator type 138 can include a manufacturer identifier, model identifier, a type of accelerator device (e.g., GPU, TPU, ASIC, FPGA), as well as whether the accelerator device has networking and DPU capabilities. The accelerator device identifier 136 and the accelerator type 138 can be stored in the data store 133 of the device 106 to which the accelerator device 161 is connected and can be transmitted to the management service 120 for storage in the accelerator registry 130.

The accelerator registry 130 can store a record for an accelerator device 161 that includes or specifies the device 106 to which it is connected, an address to access the accelerator device 161, the accelerator device identifier 136, the accelerator type 138, and an availability status. The accelerator registry 130 can specify the device 106 to which the accelerator device 161 is connected, for example, by a unique device identifier and an address for the device 106. The address for the accelerator device 161 and the device to which it is connected can include a media access control (MAC) address, an internet protocol (IP) address, a transmission control protocol (TCP) address, or another network or hardware address. The availability status can indicate whether the accelerator device 161 is available or unavailable. The accelerator registry 130 can store records for the accelerator devices 161 along with their respective information.

The accelerator broker service 129 can function as a master node among nodes comprising the various devices 106. While the accelerator broker service 129 can be executed using the cloud-based management system 103, it can also include components executed on devices 106. The accelerator broker service 129 can build and maintain the accelerator registry 130. The accelerator registry 130 can store records for accelerator devices 161 connected to and installed on devices 106, including host devices, client devices, IoT devices, edge devices, and other types of devices.

Accelerator remoting clients 149 can be executed on a variety of devices 106. Generally, the accelerator remoting clients 149 can be used to request and access accelerator devices 161 remotely, or over a network connection. Accelerator remoting servers 147 can provide networked access to accelerator devices 161 that are connected to a device 106. The accelerator remoting servers 147 can also report or register the connected accelerator devices 161 with the accelerator broker service 129. This reporting can be used as a heartbeat that indicates whether a device 106 and its connected accelerator devices 161 are online and available.

The management service 120 can include a scheduling service that monitors resource usage of the devices 106, and particularly the host devices 106 that execute enterprise workloads. This can include resource usage of accelerator devices 161 that are installed on the devices 106. While the management service 120 can schedule enterprise workloads on any device 106, whether the device 106 includes an accelerator device 161 or not. If the enterprise workload requires an accelerator device 161, the workload can perform a CUDA call, an OpenCL call, or another accelerator call to utilize an accelerator device 161.

Generally, the accelerator remoting client 149 can intercept the accelerator call. If an accelerator device 161 of the appropriate type is locally connected and has available capacity, then the accelerator call can be passed to the accelerator device 161 for local processing. However, if no accelerator device 161 is locally connected, or the locally connected accelerator device does not have available capacity, then the accelerator remoting client 149 can transmit a request for the management service 120 to provide a selected accelerator device 161 or a list of accelerator devices 161 that can perform accelerator instructions. In some cases, the request can identify a type of accelerator instructions or specify an accelerator type 138. The management service 120 can analyze usage data and available capacity for the devices 106 and accelerator devices 161 in view of the request and select an accelerator device 161. The management service 120 can return communication data that enables the accelerator remoting client 149 to transmit accelerator instructions to the accelerator remoting server 147 for execution using the accelerator device 161. In other cases, the management service 120 can return a list of available accelerator devices 161.

The accelerator remoting server 147 can access accelerator devices 161 connected to a local device bus such as USB, PCI-e bus, or another bus. An accelerator remoting server 147 can receive accelerator instructions from the accelerator remoting client 149, execute the accelerator instructions using the locally connected accelerator device 161, and transmit the results back to the accelerator remoting client 149.

The accelerator remoting server 147 and the accelerator remoting client 149 can be executed within user space or within a user space workload 141 which can be a virtual machine or a container based workload. The accelerator remoting client 149 can run as a user-space application within a user space workload 141, without the need for special software in a management hypervisor 151 and using an unmodified application or enterprise workload that uses an accelerator device 161. The accelerator remoting server 147 can be executed as a system background process and can provide the locally connected accelerator devices 161 as a resource pool to be consumed by accelerator remoting clients 149. The accelerator remoting server 147 or other management instructions can report the available and used resources of the reported pool to the management service 120. The accelerator remoting server 147 and the accelerator remoting client 149 can also be executed as separate workloads such as virtual machines or containers.

The accelerator remoting server 147 and the accelerator remoting client 149 can also be executed in kernel space within a management hypervisor 151. The accelerator remoting server 147 and the accelerator remoting client 149 can also be executed within an accelerator device 161 that includes a DPU, such as a processor-integrated networking accelerator device 161. Multiple different versions of the accelerator remoting server 147 and the accelerator remoting client 149 can be used in order to execute the accelerator remoting server 147 and the accelerator remoting client 149 in these various environments and contexts to provide cross platform operation. Cross platform operation can indicate that an accelerator remoting server 147 provides access to an accelerator device 161 through an accelerator remoting client 149, where the server and client execute on different ones of CISC and RISC hardware and include different ones of the CISC and RISC instructions.

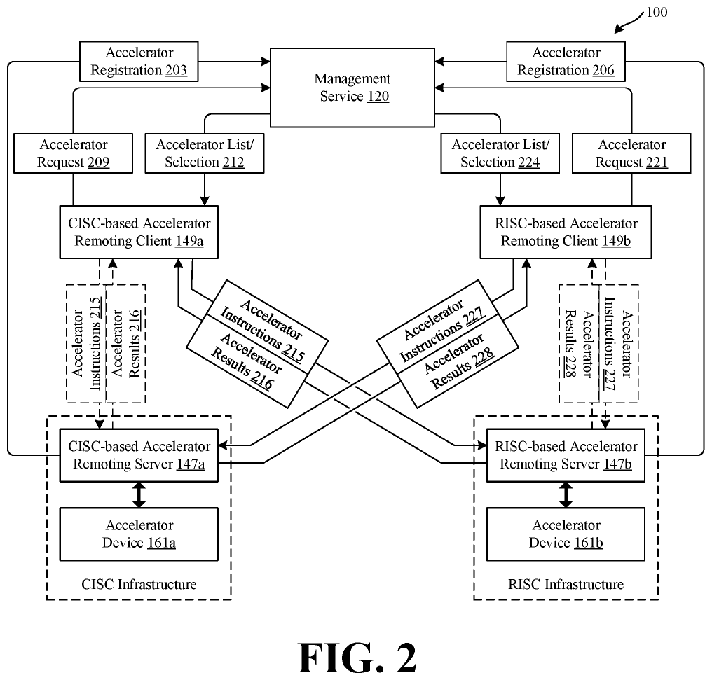

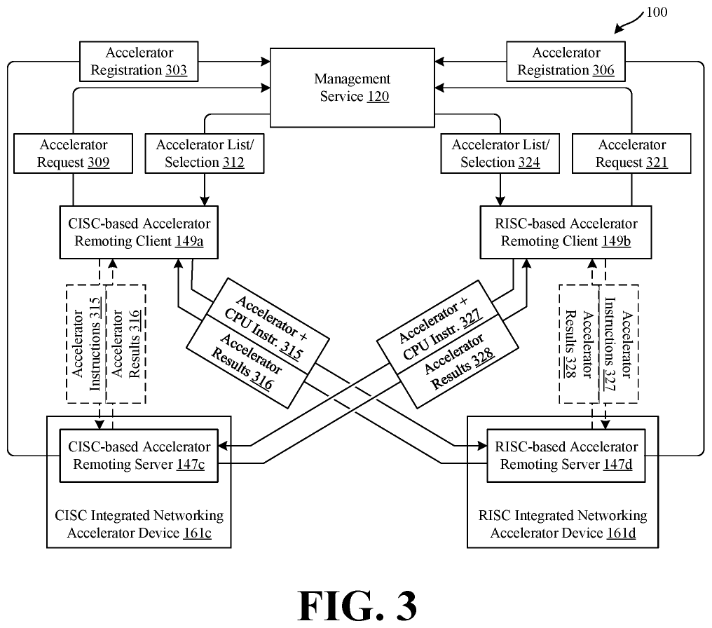

The networked environment 100 can include CISC components and RISC components, and the accelerator remoting server 147 and the accelerator remoting client 149 can provide cross platform accelerator remoting between the CISC and RISC components. The accelerator remoting server 147 can be executed on CISC or RISC hardware components and the accelerator remoting client 149 can execute in a different one of the CISC or RISC hardware components. The accelerator remoting server 147 can provide access to a CISC or RISC based processor integrated accelerator device 161, and the accelerator remoting client 149 can execute using a different one of CISC or RISC components. This is described in greater detail with respect to FIGS. 2 and 3.

The accelerator remoting server 147 and the accelerator remoting client 149 can transfer multiple sets of remoting instructions and multiple sets of accelerator results while performing an enterprise workload. An accelerator remoting server 147 can logically separate a single accelerator device 161 into multiple partial accelerators and provide the single accelerator to multiple accelerator remoting clients 149. The accelerator device 161 can be separated according to memory partitions arranged by the accelerator remoting server 147. For example, a 16 GB accelerator device 161 can be separated into two 8 GB partial accelerators and four 4 GB partial accelerators. This allows sharing the single accelerator device 161 across multiple users and even multiple different enterprises of a multi-tenant environment. When accelerator instructions for multiple enterprise workloads are scheduled on the single accelerator device 161, a separate process can be spawned for enterprise workload. This can isolate device memory and execution context for each enterprise workload.

FIG. 2 is a drawing that provides an example of the operation of components of the networked environment 100 to provide a cross platform accelerator remoting service. While the actions are discussed in a particular order, many of the actions can be performed scrambled relative to the order discussed, concurrently, and with partial concurrence. While actions can be discussed as performed by a particular component, certain aspects of the steps and actions can be performed by other components of the networked environment 100.

The networked environment 100 can include the management service 120, a CISC-based accelerator remoting client 149a, a RISC-based accelerator remoting client 149b, a CISC-based accelerator remoting server 147a, and a RISC-based accelerator remoting server 147b. The CISC-based accelerator remoting server 147a can execute in a CISC infrastructure that includes a local accelerator device 161a. The CISC infrastructure can be provided using an x68-based or another CISC-based device 106. The RISC-based accelerator remoting server 147b can execute in a RISC infrastructure that includes a local accelerator device 161b. The RISC infrastructure can be provided using an ARM-based device 106 or another RISC-based device 106.

The CISC-based accelerator remoting client 149a can include an application that is programmed and compiled to use a CISC instruction set. The CISC-based accelerator remoting server 147a can include an application that is programmed and compiled to use a CISC instruction set. The RISC-based accelerator remoting client 149b can include an application that is programmed and compiled to use a RISC instruction set. The RISC-based accelerator remoting client 149b can include a translated version of the CISC-based accelerator remoting client 149a.

The RISC-based accelerator remoting server 147b can include an application that is programmed and compiled to use a RISC instruction set. The RISC-based accelerator remoting server 147b can include a translated version of the CISC-based accelerator remoting server 147a. Some CISC instructions can include a direct translation to the RISC instruction set. Other instructions can have no direct translation to the RISC instruction set. For example, a single CISC instruction that includes a multi-step operation including load and store operations can be converted or translated into multiple RISC instructions.

RISC-based architectures can traditionally be used for mobile phones, tablets, and other mobile devices. However, IoT devices, DPUs for NICs, and host devices 106 for public, private, hybrid, and multi-cloud solutions are expanding to use RISC-based architectures. As the usage of RISC-based architectures increases, the interoperability of these architectures becomes more important. The accelerator remoting clients 149 and accelerator remoting servers 147 can enable cross platform and platform agnostic interoperability. For example, CISC-based accelerator remoting clients 149a can transmit accelerator instructions for execution on deployments of accelerator devices 161 that include or are connected to RISC-based processors; RISC-based accelerator remoting clients 149b can transmit accelerator instructions for execution on deployments of accelerator devices 161 that include or are connected to CISC-based processors.

The CISC-based accelerator remoting server 147a can transmit an accelerator registration transmission 203 to the management service 120. For example, the CISC-based accelerator remoting server 147a can identify that the accelerator device 161a is connected to the CISC infrastructure or the same device 106 that executes the CISC-based accelerator remoting server 147a. The accelerator registration transmission 203 can include information regarding the accelerator device 161a and a device 106 to which it is connected. The transmission can include the accelerator type 138 and accelerator device identifier 136 for the accelerator device 161a as well as other information.

The RISC-based accelerator remoting server 147b can transmit an accelerator registration transmission 206 to the management service 120. For example, the RISC-based accelerator remoting server 147b can identify that the accelerator device 161b is connected to the RISC infrastructure or same device 106 that executes the RISC-based accelerator remoting server 147b. The accelerator registration transmission 206 can include information regarding the accelerator device 161b and a device 106 to which it is connected. The transmission can include the accelerator type 138 and accelerator device identifier 136 for the accelerator device 161b as well as other information.

A hybrid cloud infrastructure can include both CISC and RISC-based devices 106. A hybrid cloud infrastructure can include a private cloud of devices 106 that are privately owned and operated using a suite of enterprise management software, and a cloud-based management system 103 that is accessed over a public WAN such as the Internet. The private cloud can include devices 106 that are part of a private network such as a private LAN or a private WAN. The private cloud device 106 can use x86 host devices 106, while the cloud-based management system 103 uses ARM64 host devices 106. However, a user of the private cloud can request or initiate an artificial intelligence process or another process, and a management service 120 can automatically route the process for execution using the cloud-based management system 103, using the cross platform and platform agnostic mechanisms described.

A multi-cloud infrastructure can include both CISC and RISC-based devices 106. A multi-cloud infrastructure can, for example, include a first cloud-based management system 103 for remote desktop services; and a second cloud-based management system 103 for machine learning and artificial intelligence processes. Private cloud host devices 106 can also be integrated into the overall integrated infrastructure of the networked environment 100. The first cloud-based management system 103 and the second cloud-based management system 103 can be provided by the same service provider entity or different service provider entities. In some examples, the first cloud-based management system 103 can use x86 host devices 106, while the second cloud-based management system 103 uses ARM64 host devices 106. However, a user of a remote desktop of the first cloud-based management system 103 (or a user of the private cloud) can request or initiate an artificial intelligence process, and a management service 120 can automatically route the artificial intelligence process for execution using the second cloud-based management system 103, using the cross platform and platform agnostic mechanisms described.

The management service 120 can store this information in the accelerator registry 130 and can monitor the accelerator device 161a and the accelerator device 161b along with their related devices 106. This enables a distributed resource scheduler of the management service 120 and related components on the devices 106 to perform load balancing that includes cross platform accelerator remoting between CISC-based and RISC-based architectures.

The CISC-based accelerator remoting client 149a can transmit an accelerator request 209 to the management service 120. The management service 120 can analyze usage data of an enterprise deployment of devices 106 and accelerator devices 161 to identify an accelerator device 161 that includes sufficient available capacity for the request. The request can include a capacity requirement identified based on the accelerator instructions 215.

The management service 120 can identify that accelerator device 161b has sufficient capacity for the accelerator instructions 215 based on the capacity requirement and a current available capacity of the accelerator device 161b. Otherwise, the management service 120 can identify that accelerator device 161b has sufficient capacity for the accelerator instructions 215 based on a predetermined threshold availability and the current available capacity of the accelerator device 161b.

The management service 120 can transmit an accelerator selection 212 to the CISC-based accelerator remoting client 149a, identifying the accelerator device 161b. The management service 120 can provide communication data that enables the CISC-based accelerator remoting client 149a to transmit accelerator instructions 215 to the RISC-based accelerator remoting server 147b for execution using the accelerator device 161b. In other cases, the management service 120 can return a list of available accelerator devices 161.

The CISC-based accelerator remoting client 149a can then transmit accelerator instructions 215 to the RISC-based accelerator remoting server 147b for execution. The RISC-based accelerator remoting server 147b can deliver the accelerator instructions 215 to the accelerator device 161b and return accelerator results 216 to the CISC-based accelerator remoting client 149a.

However, in another scenario, the accelerator selection 212 can identify the accelerator device 161a, and the CISC-based accelerator remoting client 149a can transmit the accelerator instructions 215 to the CISC-based accelerator remoting server 147a for execution. In other words, the selection of the accelerator remoting server 147 and accelerator device 161 can be cross platform.

The RISC-based accelerator remoting client 149b can transmit an accelerator request 221 to the management service 120. The management service 120 can analyze usage data of an enterprise deployment of devices 106 and accelerator devices 161 to identify an accelerator device 161 that includes sufficient available capacity for the request. The request can include a capacity requirement identified based on the accelerator instructions 227.

The management service 120 can identify that the accelerator device 161a has sufficient capacity for the accelerator instructions 215 based on the capacity requirement and a current available capacity of the accelerator device 161a. Otherwise, the management service 120 can identify that accelerator device 161a has sufficient capacity for the accelerator instructions 227 based on a predetermined threshold availability and the current available capacity of the accelerator device 161a. The management service 120 can transmit an accelerator selection 224 to the RISC-based accelerator remoting client 149b, identifying the accelerator device 161b. The management service 120 can provide communication data that enables the RISC-based accelerator remoting client 149b to transmit accelerator instructions 227 to the CISC-based accelerator remoting server 147a for execution using the accelerator device 161a. In other cases, the management service 120 can return a list of available accelerator devices 161.

The RISC-based accelerator remoting client 149b can then transmit accelerator instructions 227 to the CISC-based accelerator remoting server 147a for execution. The CISC-based accelerator remoting server 147a can deliver the accelerator instructions 227 to the accelerator device 161b and return accelerator results 228 to the RISC-based accelerator remoting client 149b.

However, in another scenario, the accelerator selection 224 can identify the accelerator device 161b, and the RISC-based accelerator remoting client 149b can transmit the accelerator instructions 227 to the RISC-based accelerator remoting server 147b for execution. The selection of the accelerator remoting server 147 and accelerator device 161 can be cross platform. In addition to enabling the cross platform operation, the RISC-based accelerator remoting client 149b and the RISC-based accelerator remoting server 147b can provide accelerator remoting using RISC (e.g., ARM) compatible instructions, unlike existing technologies.

FIG. 3 is another drawing that provides an example of the operation of components of the networked environment 100 to provide a cross platform accelerator remoting service. Generally, this figure shows how the components of the networked environment can utilize processor-integrated networking accelerator devices 161 to remotely perform portions of enterprise workloads that include both accelerator instructions and CPU instructions. While the actions are discussed in a particular order, many of the actions can be performed scrambled relative to the order discussed, concurrently, and with partial concurrence. While actions can be discussed as performed by a particular component, certain aspects of the steps and actions can be performed by other components of the networked environment 100.

The networked environment 100 can include the management service 120, a CISC-based accelerator remoting client 149a, a RISC-based accelerator remoting client 149b, a CISC-based accelerator remoting server 147c, and a RISC-based accelerator remoting server 147d. The CISC-based accelerator remoting server 147c can execute in a CISC infrastructure that includes a CISC integrated networking accelerator device 161c. Since it can include a CISC DPU, the CISC integrated networking accelerator device 161c can internally execute the CISC-based accelerator remoting server 147c. However, in other cases, the CISC-based accelerator remoting server 147c can execute in a device 106 to which the CISC integrated networking accelerator device 161c is connected as a card or peripheral.

The RISC-based accelerator remoting server 147d can execute in a RISC infrastructure that includes a RISC integrated networking accelerator device 161d. Since it can include a RISC DPU, the RISC integrated networking accelerator device 161d can internally execute the RISC-based accelerator remoting server 147d. However, in other cases, the RISC-based accelerator remoting server 147d can execute in a device 106 to which the RISC integrated networking accelerator device 161d is connected as a card or peripheral.

The CISC-based accelerator remoting server 147c can transmit an accelerator registration transmission 303 to the management service 120. For example, the CISC-based accelerator remoting server 147c can identify a device 106, a network address, and other information for a locally connected CISC integrated networking accelerator device 161c. The transmission can include the accelerator type 138 and accelerator device identifier 136 for the CISC integrated accelerator device 161c as well as other information. The accelerator type 138 can indicate that the accelerator device 161c is a CISC integrated networking accelerator device 161c, such as a smart or intelligent MC.

The RISC-based accelerator remoting server 147d can transmit an accelerator registration transmission 306 to the management service 120. For example, the RISC-based accelerator remoting server 147d can identify a device 106, a network address, and other information for a locally connected RISC integrated networking accelerator device 161d. The transmission can include the accelerator type 138 and accelerator device identifier 136 for the RISC integrated accelerator device 161d as well as other information. The accelerator type 138 can indicate that the accelerator device 161d is a RISC integrated networking accelerator device 161d, such as a smart or intelligent NIC.

The management service 120 can store this information in the accelerator registry 130 and can monitor the accelerator device 161c and the accelerator device 161d along with their related devices 106. This enables a distributed resource scheduler of the management service 120 and related components on the devices 106 to perform load balancing that includes cross platform accelerator remoting between CISC-based and RISC-based architectures. In addition, since the processor-integrated accelerator devices 161 include a DPU capable of executing traditional CPU instructions, a distributed resource scheduler executed by the management service 120 and associated devices 106 can schedule CPU instructions and accelerator instructions for an enterprise workload to execute on the processor-integrated accelerator devices 161. The CPU instructions and accelerator instructions can execute on a processor-integrated accelerator device 161 with available capacity even if the device 106 to which it is connected has no CPU processing capacity.

The CISC-based accelerator remoting client 149a can transmit an accelerator request 309 to the management service 120. The management service 120 can analyze usage data of an enterprise deployment of devices 106 and accelerator devices 161 to identify an accelerator device 161 that includes sufficient available capacity for the request. The request can include a capacity requirement for accelerator instructions and associated CPU instructions of a workload executed locally.

The management service 120 can identify that the RISC integrated accelerator device 161d has sufficient capacity for remoting instructions 315 that include accelerator instructions and CPU instructions based on a capacity requirement and a current available capacity of the accelerator device 161d. Otherwise, the management service 120 can identify that RISC integrated accelerator device 161d has sufficient capacity for the remoting instructions 315 based on a predetermined threshold availability and the current available capacity of the accelerator device 161d.

The management service 120 can transmit an accelerator selection 312 to the CISC-based accelerator remoting client 149a, identifying the RISC integrated networking accelerator device 161d. In some cases, the accelerator selection 312 can indicate whether or not to transmit CPU instructions along with accelerator instructions. In other cases, the accelerator request 309 can indicate that CPU instructions should be remoted along with accelerator instructions, and the management service 120 can select a processor-integrated networking accelerator device 161 based on the indication of CPU instructions along with accelerator instructions.

The management service 120 can provide communication data that enables the CISC-based accelerator remoting client 149a to transmit remoting instructions 315 including accelerator instructions and related CPU instructions to the RISC-based accelerator remoting server 147d for execution using the RISC integrated networking accelerator device 161d. In other cases, the management service 120 can return a list of available accelerator devices 161 with internal CPU instruction execution capabilities.

The CISC-based accelerator remoting client 149a can then transmit remoting instructions 315 including accelerator instructions and related CPU instructions to the RISC-based accelerator remoting server 147d for execution using the RISC integrated networking accelerator device 161d. The RISC-based accelerator remoting server 147d can deliver the remoting instructions 315 to the accelerator device 161d and return accelerator results 316 to the CISC-based accelerator remoting client 149a. In some cases, this can enable a CISC-based accelerator remoting client 149a on a CISC-based device 106 to remotely process RISC-based CPU instructions using a RISC DPU of the RISC integrated networking accelerator device 161d. To this end, the accelerator request 309 can indicate that the remoting instructions include RISC instructions, and the management service 120 can select the RISC integrated networking accelerator device 161d based on inclusion of an integrated RISC processor or DPU. However, in another scenario, the accelerator selection 312 can identify the accelerator device 161c, and the CISC-based accelerator remoting client 149a that can transmit the accelerator instructions 315 to the CISC-based accelerator remoting server 147c for execution.

The RISC-based accelerator remoting client 149b can transmit an accelerator request 321 to the management service 120. The management service 120 can analyze usage data of an enterprise deployment of devices 106 and accelerator devices 161 to identify an accelerator device 161 that includes sufficient available capacity for the request. The request can include a capacity requirement for accelerator instructions and associated CPU instructions of a workload executed locally.

The management service 120 can identify that the CISC integrated accelerator device 161c has sufficient capacity for remoting instructions 327 that include accelerator instructions and CPU instructions based on a capacity requirement and a current available capacity of the accelerator device 161c. Otherwise, the management service 120 can identify that the CISC integrated accelerator device 161c has sufficient capacity for the remoting instructions 327 based on a predetermined threshold availability and the current available capacity of the accelerator device 161c.

The management service 120 can transmit an accelerator selection 324 to the RISC-based accelerator remoting client 149b, identifying the CISC integrated networking accelerator device 161c. In some cases, the accelerator selection 324 can indicate whether or not to transmit CPU instructions along with accelerator instructions. In other cases, the accelerator request 321 can indicate that CPU instructions should be remoted along with accelerator instructions, and the management service 120 can select a processor-integrated networking accelerator device 161 based on the indication of CPU instructions along with accelerator instructions.

The management service 120 can provide communication data that enables the RISC-based accelerator remoting client 149b to transmit remoting instructions 327 including accelerator instructions and related CPU instructions to the CISC-based accelerator remoting server 147c for execution using the CISC integrated networking accelerator device 161c. In other cases, the management service 120 can return a list of available accelerator devices 161 with internal CPU instruction execution capabilities.

The RISC-based accelerator remoting client 149b can then transmit remoting instructions 327 including accelerator instructions and related CPU instructions to the CISC-based accelerator remoting server 147c for execution using the CISC integrated networking accelerator device 161c. The RISC-based accelerator remoting server 147d can deliver the remoting instructions 327 to the accelerator device 161c and return accelerator results 328 to the RISC-based accelerator remoting client 149b. In some cases, this can enable a RISC-based accelerator remoting client 149b on a RISC-based device 106 to remotely process CISC-based CPU instructions using a CISC DPU of the CISC integrated networking accelerator device 161c. To this end, the accelerator request 321 can indicate that the remoting instructions include CISC instructions, and the management service 120 can select the CISC integrated networking accelerator device 161c based on inclusion of an integrated CISC processor or DPU. However, in another scenario, the accelerator selection 312 can identify the accelerator device 161d, and the RISC-based accelerator remoting client 149b can transmit the accelerator instructions 327 to the RISC-based accelerator remoting server 147d for execution.

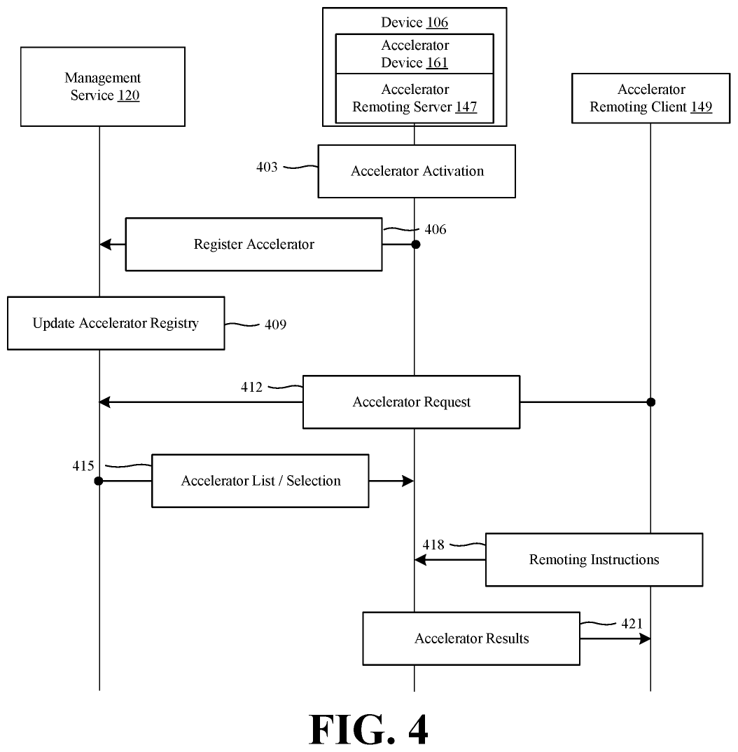

FIG. 4 is a sequence diagram illustrating functionality implemented by components of the networked environment 100. While the steps and actions are discussed in a particular order, many of the steps and actions can be performed scrambled relative to the order discussed, concurrently, and with partial concurrence. While steps and actions can be discussed as performed by a particular component, certain aspects of the steps and actions can be performed by other components of the networked environment 100.

In step 403, the accelerator remoting server 147 can detect the connection and installation of an accelerator device 161 on a local device 106. For example, the accelerator remoting server 147 can monitor the local device 106 to detect a connection or installation of the accelerator device 161. This can include monitoring an operating system or a list of connected devices of the local device 106 for a known list of accelerator devices 161. The accelerator remoting server 147 can identify a list of all accelerator devices 161 connected to the device 106.

In step 406, the accelerator remoting server 147 can register the accelerator device 161 with the management service 120, for example, using an accelerator broker service 129. The accelerator remoting server 147 can transmit a list of the accelerator devices 161 that are connected to the local device 106 on which the accelerator remoting server 147 is installed. The list can specify, for each accelerator device 161, an availability status, a network or hardware address, an accelerator device identifier 136, and an accelerator type 138. The list can also include a unique device identifier and an address of the device 106. The accelerator device identifier 136 can include a unique device identifier of the accelerator device 161. In some cases, the address can be utilized as an accelerator device identifier 136. The accelerator type 138 can include a manufacturer identifier, model identifier, and a type of accelerator algorithm performed by the accelerator device 161.

In step 409, the management service 120 can register or update a record for the accelerator device 161 in the accelerator registry 130. The accelerator registry 130 can include records for accelerator devices 161 that are connected to nodes including multiple devices 106 on a particular intranet, extranet, public WAN, private LAN, wired network, wireless network, private cloud, public cloud, hybrid cloud, multi-cloud environment, or another suitable network.

In step 412, the accelerator remoting client 149 can transmit an accelerator request to the management service 120. For example, the accelerator remoting client 149 can intercept a CUDA call or another accelerator call by an application such as an enterprise workload. The accelerator request can be a request for an accelerator device 161 that the accelerator remoting client 149 can utilize to perform accelerator instructions of the enterprise workload. In some cases, the enterprise workload can include accelerator instructions and CPU instructions. The accelerator request can indicate one or more of a type of AI algorithm, a type of hardware, a type of technique, an accelerator type, capacity requirements, and whether the accelerator instructions include related CPU instructions. Alternatively, the accelerator request can request all available accelerator devices 161.

In step 415, the management service 120 can access the accelerator registry 130 to identify an available accelerator device 161 of the appropriate type and with sufficient capacity for the accelerator request. This can include identifying an accelerator 161 that includes a type of accelerator required for the accelerator instructions if the accelerator instructions are accelerator type specific, and a type of DPU for any CPU instructions if the CPU instructions are included and are CPU type specific. CPU type can refer to RISC and CISC types. The management service 120 can then return communication information that enables the accelerator remoting client 149 to communicate with the accelerator remoting server 147 executed in association with the selected accelerator 161. For example, the accelerator remoting server 147 can be executed on the device 106 to which the accelerator device 161 is installed or can be executed directly by a DPU of the accelerator device 161.

The management service 120 can select a particular accelerator device 161 based on predetermined criteria and can return information for a selected accelerator device 161. The predetermined criteria can be compared among accelerator devices 161 that match the type of algorithm, type of hardware, and type of technique, type of accelerator, and type of CPU or CPU instruction set indicated in the request. The predetermined criteria can include shortest physical distance, lowest latency, and lowest network utilization for the device 106 and accelerator device 161. However, in cases where the device 106 CPU has no capacity or insufficient capacity, a processor-integrated accelerator device 161 can nevertheless be selected based on its internal available capacity for CPU and accelerator instructions.

In step 418, the accelerator remoting client 149 can transmit remoting instructions to the accelerator remoting server 147. The remoting instructions can include CPU instructions and accelerator instructions. If a list of accelerators 161 is provided rather than a selected accelerator device 161, then the accelerator remoting client 149 can select one of the accelerator devices 161 based on predetermined criteria as discussed above, or the accelerator device 161 can be manually or user-selected. The accelerator remoting server 147 can provide the remoting instructions to the accelerator device 161. The accelerator device 161 can then execute the remoting instructions, including accelerator instructions and CPU instructions. The accelerator device 161 can execute CPU instructions using an integrated DPU.

In step 421, accelerator remoting server 147 can transmit accelerator results to the accelerator remoting client 149. The accelerator results can include parameters that are output as a result of execution of the remoting instructions, including the accelerator instructions and any CPU instructions.

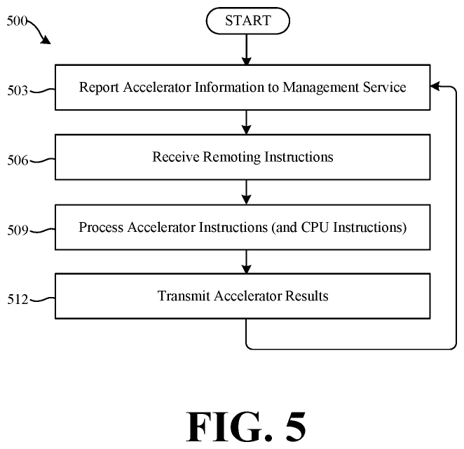

FIG. 5 is a flowchart 500 illustrating functionality implemented by components of the networked environment 100. The flowchart 500 describes how the accelerator remoting server 147 executing on a local device 106 with an accelerator device 161 coordinates with the other components of the networked environment 100 including an accelerator remoting client 149 to provide access to an accelerator device 161 as a network service.

In step 503, the accelerator remoting server 147 can report accelerator information to a management service 120. The accelerator remoting server 147 can identify accelerator devices 106 operated on the same device 106 that executes the accelerator remoting server 147. The accelerator remoting server 147 can monitor the local device 106 to detect a presence of an accelerator device 161 or an additional accelerator device 161. This can include monitoring an operating system or a list of connected devices of the local device 106 and comparing to a known list of accelerator devices 161.

The accelerator remoting server 147 can transmit a list of the accelerator devices 161 that are connected to the local device 106 on which the accelerator remoting server 147 is installed. The list can specify, for each accelerator device 161, an availability status, a network or hardware address, an accelerator device identifier 136, and an accelerator type 138. The list can also include a unique device identifier and an address of the local device 106. The accelerator device identifier 136 can include a unique device identifier of the accelerator device 161. In some cases, the address can be utilized as an accelerator device identifier 136. The accelerator type 138 can include or be associated with a manufacturer identifier, model identifier, and a type of algorithm, and other information as discussed.

In step 506, the accelerator remoting server 147 can receive remoting instructions as a processing request. The remoting instructions can be received from an accelerator remoting client 149. The remoting instructions can specify the accelerator device 161 that is connected to the local device 106 of the accelerator remoting server 147. The remoting instructions can include accelerator instructions and in some cases CPU instructions for execution using the specified accelerator device 161. In some cases, the accelerator remoting server 147 can receive the remoting instructions, create a partial accelerator using a memory segment sufficient to perform the accelerator instructions and CPU instructions, and assign the remoting instructions to the partial accelerator. In other examples the accelerator remoting server 147 can assign the remoting instructions to a preexisting partial accelerator, or the full accelerator device 161 can be used.

In step 509, the accelerator remoting server 147 can provide the remoting instructions including the accelerator instructions and any CPU instructions to the accelerator device 161. The accelerator device 161 can perform the remoting instructions and provide accelerator results including one or more output parameters and other data.

In step 512, the accelerator remoting server 147 can transmit accelerator results to the accelerator remoting client 149. The accelerator remoting server 147 can also transmit a message or other data indicating that the workload or the current set of remoting instructions is completed. The accelerator remoting server 147 and the accelerator remoting client 149 can transfer multiple sets of remoting instructions and multiple sets of accelerator results while performing an enterprise workload.

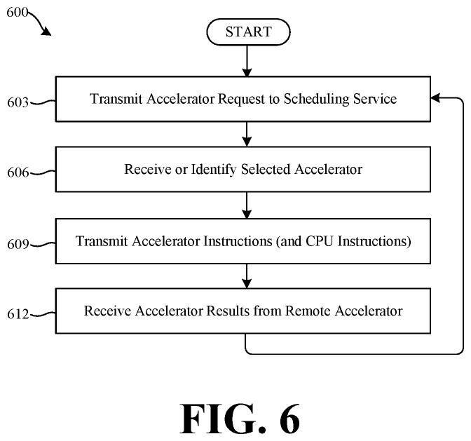

FIG. 6 is a flowchart 600 illustrating functionality implemented by components of the networked environment 100. The flowchart 600 describes how the accelerator remoting client 149 coordinates with the other components of the networked environment 100 including an accelerator remoting server 147 to provide remote access to an accelerator device 161 as a network service.

In step 603, the accelerator remoting client 149 can transmit an accelerator request to the management service 120. The management service 120 can be a service executed in a public cloud, private cloud, hybrid cloud, or multi-cloud environment. The accelerator request can include a capacity requirement such as a memory requirement and a processor requirement for accelerator instructions and associated CPU instructions of an enterprise workload. The accelerator request can also indicate a type of accelerator corresponding to a type of accelerator instructions, and a type of CPU corresponding to a type of CPU instructions.

In step 606, the accelerator remoting client 149 can receive a selected accelerator device 161 from the management service 120. The selected accelerator can be an available accelerator device 161 that matches a type of AI algorithm, type of hardware, and type of technique, type of CPU, and type of accelerator that is indicated in the request. The management service 120 can select the accelerator device 161 based on predetermined criteria and can return information for a selected accelerator device 161. The predetermined criteria can be compared among accelerator devices 161 that match the type of AI algorithm, type of hardware, and type of technique, type of CPU, and type of accelerator that is indicated in the request. The predetermined criteria can include the lowest network utilization for the device to which the accelerator device 161, shortest physical distance, lowest latency, and other criteria. In other cases, the accelerator remoting client 149 can receive a list of accelerator devices 161 that match the type of AI algorithm, type of hardware, and type of technique, type of CPU, and type of accelerator. The accelerator remoting client 149 can select the accelerator device 161 manually based on user input or based on the predetermined criteria. Communication information for the accelerator device 161, including its address, accelerator device identifier 136, and a network communication endpoint for an associated accelerator remoting server 147 locally executed with the accelerator device 161 can also be provided.

In step 609, accelerator remoting client 149 can transmit remoting instructions to the accelerator remoting server 147. The remoting instructions can specify the selected accelerator device 161 and can be directed to the accelerator remoting server 147. The remoting instructions can include accelerator instructions as well as any associated CPU instructions.

In step 612, accelerator remoting client 149 can receive an accelerator result that includes output parameters resulting from execution of the remoting instructions. The accelerator remoting server 147 and the accelerator remoting client 149 can transfer multiple sets of remoting instructions and multiple sets of accelerator results while performing an enterprise workload.

A number of software components are stored in the memory and executable by a processor. In this respect, the term “executable” means a program file that is in a form that can ultimately be run by the processor. Examples of executable programs can be, for example, a compiled program that can be translated into machine code in a format that can be loaded into a random access portion of one or more of the memory devices and run by the processor, code that can be expressed in a format such as object code that is capable of being loaded into a random access portion of the one or more memory devices and executed by the processor, or code that can be interpreted by another executable program to generate instructions in a random access portion of the memory devices to be executed by the processor. An executable program can be stored in any portion or component of the memory devices including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

Memory can include both volatile and nonvolatile memory and data storage components. Also, a processor can represent multiple processors and/or multiple processor cores, and the one or more memory devices can represent multiple memories that operate in parallel processing circuits, respectively. Memory devices can also represent a combination of various types of storage devices, such as RAM, mass storage devices, flash memory, or hard disk storage. In such a case, a local interface can be an appropriate network that facilitates communication between any two of the multiple processors or between any processor and any of the memory devices. The local interface can include additional systems designed to coordinate this communication, including, for example, performing load balancing. The processor can be of electrical or of some other available construction.

Although the various services and functions described herein can be embodied in software or code executed by general purpose hardware as discussed above, as an alternative, the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include discrete logic circuits having logic gates for implementing various logic functions upon an application of one or more data signals, application specific integrated circuits (ASICs) having appropriate logic gates, field-programmable gate arrays (FPGAs), or other components.

The sequence diagram and flowcharts show are examples of the functionality and operation of an implementation of portions of components described herein. If embodied in software, each block can represent a module, segment, or portion of code that can include program instructions to implement the specified logical function(s). The program instructions can be embodied in the form of source code that can include human-readable statements written in a programming language or machine code that can include numerical instructions recognizable by a suitable execution system such as a processor in a computer system or other system. The machine code can be converted from the source code. If embodied in hardware, each block can represent a circuit or a number of interconnected circuits to implement the specified logical function(s).

Although the sequence diagram and flowcharts are shown in a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the drawings can be skipped or omitted.

Also, any logic or application described herein that includes software or code can be embodied in any non-transitory computer-readable medium for use by or in connection with an instruction execution system such as a processor in a computer system or other system. In this sense, the logic can include, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can include any one of many physical media, such as magnetic, optical, or semiconductor media. More specific examples of a suitable computer-readable medium include solid-state drives or flash memory. Further, any logic or application described herein can be implemented and structured in a variety of ways. For example, one or more applications can be implemented as modules or components of a single application. Further, one or more applications described herein can be executed in shared or separate computing devices or a combination thereof. For example, a plurality of the applications described herein can execute in the same computing device, or in multiple computing devices.

It is emphasized that the above-described embodiments of the present disclosure are merely possible examples of implementations described for a clear understanding of the principles of the disclosure. Many variations and modifications can be made to the above-described embodiments without departing substantially from the spirit and principles of the disclosure. All such modifications and variations are intended to be included in the following claims herein, within the scope of this disclosure.

Therefore, the following is claimed:

1. A system for cross platform accelerator remoting, comprising:
at least one computing device comprising at least one processor and a data store; and
the data store comprising executable instructions, wherein the instructions, when executed by the at least one processor, cause the at least one computing device to at least:
execute, in a computing environment comprising complex instruction set computer (CISC) components and reduced instruction set computer (RISC) components, an accelerator remoting server and an accelerator remoting client that provide cross platform accelerator remoting between the CISC and RISC components;
receive, by the accelerator remoting server, accelerator instructions for an accelerator device installed to a computing device that executes the accelerator remoting server, the accelerator instructions being received from the accelerator remoting client;
provide, by the accelerator remoting server, the accelerator instructions to consume at least a portion of the accelerator device using the accelerator instructions received from the accelerator remoting client; and
transmit, by the accelerator remoting server to the accelerator remoting client, accelerator results comprising at least one parameter output based on the accelerator instructions to complete the cross platform accelerator remoting.

2. The system of claim 1, wherein the accelerator remoting server provides the accelerator device as a resource to be distributed and consumed by components of a management service.

3. The system of claim 1, wherein the accelerator remoting server is executed in user space as a background process.

4. The system of claim 1, wherein the instructions, when executed by the at least one processor, cause the at least one computing device to at least:
transmit, by the accelerator remoting server to a management service, accelerator data comprising an accelerator type of the accelerator device.

5. The system of claim 1, wherein the accelerator instructions are received along with central processing unit instructions to be executed using a data processing unit that is integrated with the accelerator device.

6. The system of claim 1, wherein the computing environment is a hybrid cloud computing environment comprising a first computing device in a private network and a second computing device accessed using a public wide area network (WAN), the first computing device comprising a particular one of the CISC components or the RISC components, and the second computing device comprising a different one of the CISC components and the RISC components.

7. The system of claim 1, wherein the accelerator remoting server comprises a particular one of CISC instructions or RISC instructions, and the accelerator remoting client comprises a different one of the CISC instructions or the RISC instructions.

8. A non-transitory computer-readable medium comprising executable instructions, wherein the instructions, when executed by at least one processor, cause a computing device to at least:
execute, in a computing environment comprising complex instruction set computer (CISC) components and reduced instruction set computer (RISC) components, an accelerator remoting server and an accelerator remoting client that provide cross platform accelerator remoting between the CISC and RISC components;
receive, by the accelerator remoting server, accelerator instructions for an accelerator device installed to a computing device that executes the accelerator remoting server, the accelerator instructions being received from the accelerator remoting client;
provide, by the accelerator remoting server, the accelerator instructions to consume at least a portion of the accelerator device using the accelerator instructions received from the accelerator remoting client; and
transmit, by the accelerator remoting server to the accelerator remoting client, accelerator results comprising at least one parameter output based on the accelerator instructions to complete the cross platform accelerator remoting.

9. The non-transitory computer-readable medium of claim 8, wherein the accelerator remoting server provides the accelerator device as a resource to be distributed and consumed by components of a management service.

10. The non-transitory computer-readable medium of claim 8, wherein the accelerator remoting server is executed in user space as a background process.

11. The non-transitory computer-readable medium of claim 8, wherein the instructions, when executed by the at least one processor, cause the at least one computing device to at least:
transmit, by the accelerator remoting server to a management service, accelerator data comprising an accelerator type of the accelerator device.

12. The non-transitory computer-readable medium of claim 8, wherein the accelerator instructions are received along with central processing unit instructions to be executed using a data processing unit that is integrated with the accelerator device.

13. The non-transitory computer-readable medium of claim 12, wherein the computing environment is a hybrid cloud computing environment comprising a first computing device in a private network and a second computing device accessed using a public wide area network (WAN), the first computing device comprising a particular one of the CISC components or the RISC components, and the second computing device comprising a different one of the CISC components and the RISC components.

14. The non-transitory computer-readable medium of claim 13, wherein the accelerator remoting server is executed using a particular one of the first computing device or the second computing device, and the accelerator remoting client is executed using a different one of the first computing device or the second computing device.

15. A method performed by instructions executed by a computing device, the method comprising:
executing, in a computing environment comprising complex instruction set computer (CISC) components and reduced instruction set computer (RISC) components, an accelerator remoting server and an accelerator remoting client that provide cross platform accelerator remoting between the CISC and RISC components;
receiving, by the accelerator remoting server, accelerator instructions for an accelerator device installed to a computing device that executes the accelerator remoting server, the accelerator instructions being received from the accelerator remoting client;
providing, by the accelerator remoting server, the accelerator instructions to consume at least a portion of the accelerator device using the accelerator instructions received from the accelerator remoting client; and
transmitting, by the accelerator remoting server to the accelerator remoting client, accelerator results comprising at least one parameter output based on the accelerator instructions to complete the cross platform accelerator remoting.

16. The method of claim 15, wherein the accelerator remoting server provides the accelerator device as a resource to be distributed and consumed by components of a management service.

17. The method of claim 15, wherein the accelerator remoting server is executed in user space as a background process.

18. The method of claim 15, further comprising:
transmitting, by the accelerator remoting server to a management service, accelerator data comprising an accelerator type of the accelerator device.

19. The method of claim 15, wherein the computing environment is a hybrid cloud computing environment comprising a first computing device in a private network and a second computing device accessed using a public wide area network (WAN), the first computing device comprising a particular one of the CISC components or the RISC components, and the second computing device comprising a different one of the CISC components and the RISC components.

20. The method of claim 19, wherein the computing environment is a multi-cloud computing environment comprising a first computing device of a first public-cloud infrastructure accessed using a public wide area network (WAN) and a second computing device of a second public-cloud infrastructure accessed using the public WAN, the first computing device comprising a particular one of the CISC components or the RISC components, and the second computing device comprising a different one of the CISC components and the RISC components.
